(19) United States
(12) Patent Application Publication
(10) Pub. No.: US 2006/0097228 A1
(43) Pub. Date: May 11, 2006

(54) Continuous synthetic process of phosphor in supercritical water and apparatus being used therein

(76) Inventors: Jae Wook Lee, Daedeok-gu (KR); Chang Ha Lee, Seoul (KR); Hyeon Cheol Lee, Seoul (KR); Jung Hyun In, Yesan-gun (KR); Man Gap Han, Yuseong-gu (KR)

Correspondence Address: LADAS & PARRY LLP, 224 SOUTH MICHIGAN AVENUE, SUITE 1600, CHICAGO, IL, 60604, US

(21) Appl. No.: 11/271,099

(22) Filed: Nov. 10, 2005

(30) Foreign Application Priority Data
Nov. 11, 2004 (KR) 10-2004-0092028

(51) Int. Cl. C09K 11/08; B01J 19/00

(52) U.S. Cl. 252/301.4 R; 422/224; 422/198

(57) ABSTRACT

The present invention relates to a method of continuously producing a phosphor at a supercritical water (SCW) condition and an apparatus used in the method. A phosphor produced according to the method of the present invention has similar luminosity to a phosphor produced according to a conventional solid-state method and the size and shape of particles thereof is also uniform. Accordingly, a phosphor according to the method of the present invention is applicable in various fields such as plasma display (PDP) and field emission display (FED). Also, in the method of producing a phosphor according to the present invention, the total reaction time is within about one minute, which is shorter than in the solid-state method. Also, since a separate heat processing process is not needed to obtain crystallized particles, it is efficient in aspects of time and energy.

### CROSS-REFERENCE TO RELATED APPLICATION

This application claims the benefit of Korean Patent Application No. 2004-92028, filed on Nov. 11, 2004, in the Korean Intellectual Property Office, the disclosure of which is incorporated herein in its entity by reference.

### BACKGROUND OF THE INVENTION

1. Field of the Invention

The present invention relates to a method of continuously producing a phosphor at a supercritical water (SCW) condition and an apparatus used in the method.

2. Description of the Related Art

A phosphor is being used in various fields as a luminescent material that absorbs radiation energy in a portion of electromagnetic spectrum and emits energy in another portion of the electromagnetic spectrum.

As an example, a phosphor has been used in a display device and a lamp. Sulfide-based phosphors have been used as a phosphor for a conventional display and lamp. The sulfide-based phosphors usually contain a host such as ZnS, CdS, ZnCdS or the like, doped with precious metals. The sulfide-based phosphors described above have been researched and developed for several decades. Currently, the efficiency of the sulfide-based phosphors has been accomplished to a level where it is hard to expect more improvement thereof. Accordingly, just until a few years ago, phosphors have been studied by an extremely small number of researchers.

However, as concerns about high definition television (HDTV) currently increase, the development of displays also becomes increasingly active. Plasma display (PDP) and field emission display (FED) are currently in the spotlight as representative displays. The displays as above are lightweight and thin which is different from a conventional display. Due to the above characteristics, the displays as above are applicable in various fields such as wall-mounted televisions, computers, camcorders, navigation systems, and the like. Also, the displays are gaining the interests of people.

Also, since the sulfide-based phosphor has an excellent luminescent property, a conventional cathode ray tube display (CRT) has no difficulty in adopting the sulfide-based phosphor. However, PDP and FED have difficulty in using a conventional sulfide-based phosphor. Namely, in the case of the PDP and FED, phosphors emit light in a high-degree vacuum state. Accordingly, in the case of using a conventional sulfide-based phosphor, a vacuum state and capacity may be deteriorated by dissolution of the sulfide-based phosphor.

However, unlike a sulfide-based phosphor, an oxide-based phosphor is very stable with respect to an electron beam or ultraviolet ray that is a source of energy to emit light in a display. Due to the above characteristic, the oxide-based phosphor is being used as a phosphor for PDP. Representative examples include aluminate, silicate, titanate, borates, and the like.

Oxide-based phosphors consisting of multi-ingredients using materials described above are usually produced by a solid-state method. In the solid-state method, oxide-based phosphors consisting of multi-ingredients are produced by mixing oxides of each ingredient and repeating a hot heat treatment and a grinding process. Accordingly, a heat treatment and a time consuming process have to be completed to obtain oxide-based phosphors consisting of multi-ingredients. Also, impurities may be contained in phosphor particles while passing through a repeating heat treatment and grinding process.

To solve the above problems of the solid-state method, a method using a liquid phase method has been researched. A liquid phase method such as a coprecipitation method or a sol-gel method may produce phosphors consisting of multi-ingredients at a very low temperature. Also, it is expected to produce phosphors with good fluorescent properties even at a comparatively lower temperature. However, oxide-based phosphors of multi-ingredients may not be used for PDP because the shape of particles thereof is very uneven. Also, the solid-state method and the liquid phase method are produced in batches. Accordingly, in the case of mass production, cost may be increased.

Accordingly, there is needed a method capable of continuously producing phosphors of which the size and shape of particles is uniform and with excellent luminescent properties. This is to widely adopt phosphors produced as above in fields such as PDP, FED, and conventional CRT and lamp through a more simplified process.

### SUMMARY OF THE INVENTION

The present inventors have made great efforts to develop a method for continuously producing various phosphors having uniform size and shape through a simple process. If phosphors are produced by continuously supplying raw materials into a reactor at a supercritical water (SCW) condition, it is possible to produce crystallized particles in a short time because of the characteristic of the supercritical water. Accordingly, since a heat treatment process that is a post-processing procedure becomes unnecessary, it is possible to reduce a reaction time and use of energy and continuously produce phosphors having uniform size and shape. The present invention has been completed on the basis of the facts described above.

Accordingly, the present invention provides a method capable of continuously producing a phosphor having uniform size and shape with a simple process and in a short time by using SCW.

The present invention also provides a phosphor produced according to the above method.

The present invention also provides an apparatus used in producing the above phosphor.

To achieve the above objectives, according to an aspect of the present invention, there is provided a method of producing a phosphor, and the method comprises: mixing together a water-soluble metal salt solution containing a host and an activator doping the host and an alkaline solution to react to each other, and converting the water-soluble metal salt solution to a hydroxide salt solution; mixing together the hydroxide salt solution and preheated water and maintaining a temperature of the mixed solution in a range from about 150 to about 200° C.; injecting the mixed solution into a main reactor in which a state of supercritical water is maintained to produce phosphor particles; and retrieving the produced phosphor particles by condensing, filtering and drying the same.

According to another aspect of the present invention, there is provided a reactor for producing a phosphor including: an inlet supplying a water-soluble metal salt solution containing a host and an activator doping the host and an alkaline solution; a mixer mixing together the water-soluble metal salt solution and the alkaline solution supplied from the inlet; a main reactor connected to the mixer and maintaining a supercritical water condition therein to produce the phosphor; a pre-heater for supplying preheated water to between the mixer and the main reactor; a condenser condensing phosphor particles produced at the main reactor to be condensed; and a reservoir filter retrieving the condensed phosphor particles.

### BRIEF DESCRIPTION OF THE DRAWINGS

The above and other features and advantages of the present invention will become more apparent by describing in detail exemplary embodiments thereof with reference to the attached drawings in which:

FIG. 1 is a cross-sectional view illustrating a reactor for producing a phosphor at a supercritical water (SCW) condition according to the present invention;

FIG. 2 is an enlarged view of part “A” in FIG. 1;

FIG. 3 is a graph illustrating analysis results of X-ray diffraction (XRD) of YAG:Eu phosphor produced according to a method of the present invention;

FIG. 4 is a graph illustrating XRD analysis results of YAG:Eu phosphor according to a conventional solid-state method;

FIG. 5 is a scanning electric microscope (SEM) picture of YAG:Eu phosphor produced according to the method of the present invention;

FIG. 6 is an SEM picture of YAG:Eu phosphor produced according to the conventional solid-state method;

FIG. 7 is a graph illustrating results of luminosity of YAG:Eu phosphor produced according to the method of the present invention and the conventional solid-state method via photoluminescence (PL);

FIG. 8 is a graph illustrating XRD analysis results of YAG:Tb phosphor produced according to the present invention;

FIG. 9 is an SEM picture of YAG:Tb phosphor produced according to the method of the present invention; and

FIG. 10 is a graph illustrating results of luminosity of YAG:Tb phosphor produced according to the method of the present invention via PL.

### DETAILED DESCRIPTION OF THE INVENTION

Hereinafter, the present invention will be described in detail with reference to the accompanying drawings.

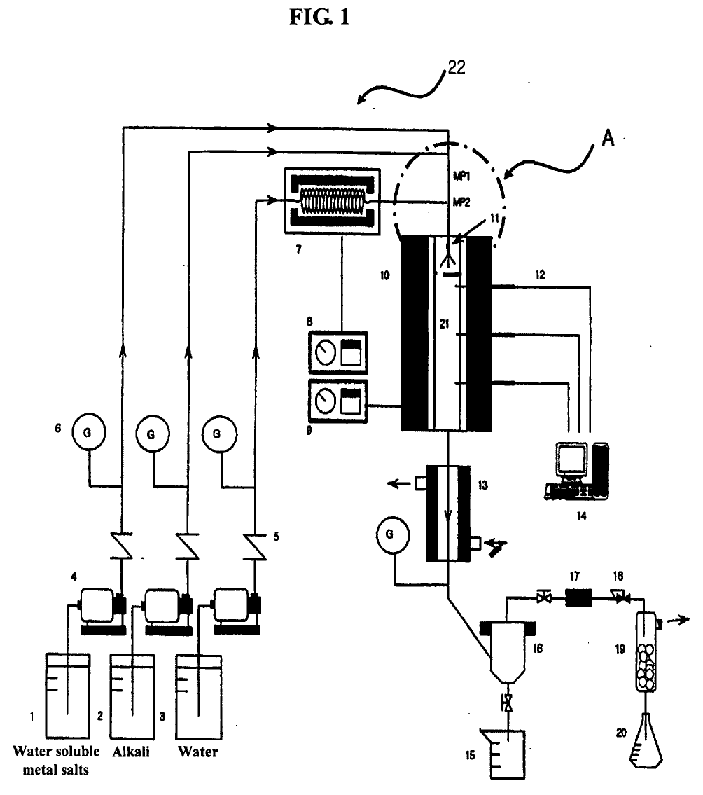

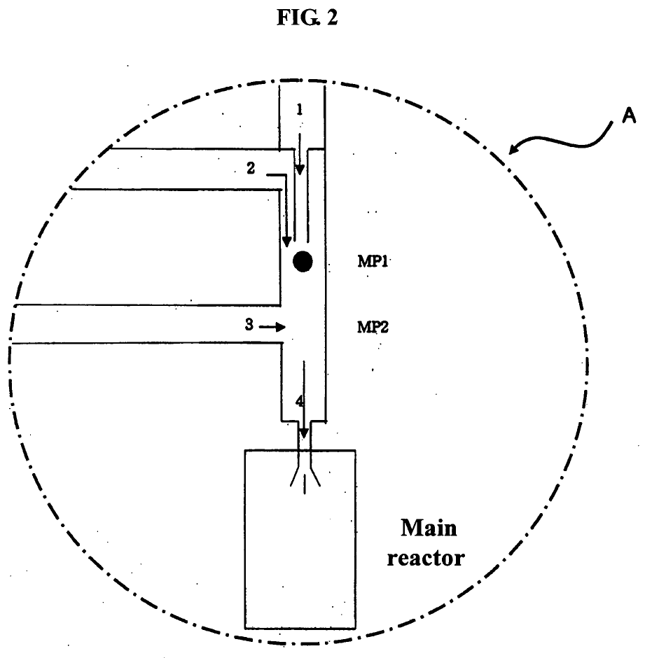

A method of producing a phosphor according to the present invention may be performed by using a reactor used to produce a phosphor at a supercritical water (SCW) condition. Referring to FIGS. 1 and 2, the present invention may produce YAG (Y₃Al₅O₁₂) phosphor doped with rare-earth metals by using a reactor for producing phosphors as illustrated in FIGS. 1 and 2. First, a water-soluble metal salt solution is mixed together with an alkaline solution at room temperature, which makes a metal salt aqueous solution convert into a hydroxide salt solution having a pH of about 7.1 to about 12. In this instance, the water-soluble metal salt solution and the alkaline solution are ingredients of a phosphor to be produced. After this, the hydroxide salt solution is mixed together with preheated water and the temperature of the mixed solution is maintained to be in a range from about 150 to about 200° C. Also, the mixed solution is injected into a main reactor maintaining a state of SCW therein, and phosphor particles are produced in the main reactor. In this manner, the YAG (Y₃Al₅O₁₂) phosphor doped with rare-earth metals may be produced.

Hereinafter, a method of producing a phosphor at a condition of SCW will be described for each process.

First Process: Converting Water-Soluble Metal Salt Solution of a Raw Material to Hydroxide Salt Solution.

In this process, a raw material fitting a stoichiometry of a phosphor to be produced is mixed together with an alkaline solution to convert a pH of the raw material into an alkaline condition. In this case, the raw material comprises a host and an activator doping the host, and the host and the activator may respectively comprise a water-soluble metal salts such as a nitrate, an acetate, a hydrochloride, etc. A nitrate is preferably used. Water-soluble salts of yttrium (Y) or aluminum (Al) may be used as a host. Also, rare-earth metals, more specifically water-soluble salts such as scandium (Sc), ytterbium (Yb), lanthanum (La), cerium (Ce), praseodymium (Pr), neodymium (Nd), samarium (Sm), europium (Eu), gadolinium (Gd), terbium (Tb), dysprosium (Dy), holmium (Ho), erbium (Er), thulium (Tm), yttrium (Y), and lutetium (Lu) may be used as the activator. These can be used alone or in a combination thereof.

The water-soluble salt is mixed together with an alkaline solution in a mixer MP1 of a reactor 22 to produce a phosphor, and the water-soluble salt is converted into a hydroxide salt.

In this case, there is no particular constraint on the type of alkaline solution but a potassium hydroxide solution is preferable. The amount of the alkaline solution may be used so that the final pH of a mixed solution is in a range of about 7.1 to about 12. This is because a phosphor is not produced in an acidic condition, and the water-soluble salt, such as a nitrate, may be converted into the hydroxide salt to form a highly supersaturated solution, to thereby produce a nano-phosphor.

Converting the water-soluble metal salt into a hydroxide salt is performed at room temperature in the mixer MP1 of the reactor 22 of the present invention. Referring now to FIG. 2, when a water soluble metal salt is supplied via a first transfer pipe and an alkaline solution is supplied via a second transfer pipe by using a high-pressure pump in an inlet 4 of the reactor 22, the first transfer pipe and the second transfer pipe are spatially connected to each other at the end portion of the first transfer pipe. Also, an alkaline solution is transferred to between the first transfer pipe and the second transfer pipe which are connected to each other as described as above. Accordingly, a metal salt solution and an alkaline solution are mixed together to chemically react to each other in the MP1, which converts the water-soluble metal salt to a hydroxide salt. In this instance, since the end portion of the first transfer pipe is formed of a through-tube in the shape of a nozzle, the first transfer pipe and the second transfer pipe are spatially connected to each other.

A mixture reaction time of a water-soluble metal salt and an alkaline solution may be controlled in accordance with a position of the MP1. Accordingly, a time for forming a nucleus can be controlled. In the present invention, the MP1 is positioned between the connection portion of the first and second transfer pipes and a cross portion of the second transfer pipe and a third transfer pipe supplying preheated water. Thus, a time to form a nucleus is reduced by decreasing a mixture time to a minimum.

Second Process: Maintaining Temperature of Mixed Solution in Range from about 150 to about 200° C.

The solution converted into a hydroxide salt is mixed together with preheated water in the MP2. The preheated water is preheated to be in a high temperature and supplied via the third transfer pipe. Namely, the hydroxide salt solution is at room temperature, but directly mixed together with preheated water in the MP2. In this instance, the preheated water is preheated to be in a temperature from about 500 to about 600° C. by using a pre-heater 7. The temperature of the mixed solution is in a range from about 150 to about 200° C.

When a hydroxide salt solution at room temperature is directly supplied into a main reactor that has been controlled to be in a SCW condition, the temperature of the main reactor becomes very different between an upper portion and a lower portion. Therefore, a distribution of phosphor particles produced in the reactor may be irregular. Accordingly, this second process is performed to maintain a uniform temperature through the second process, to thereby uniformize the distribution of the phosphor particles.

Third Process: Producing Phosphor Particles

Since the mixer MP2 and a main reactor 21 of the reactor 22 are connected to each other, the mixed solution maintained at a temperature of about 150 to about 200° C. is directly supplied into the main reactor 21 to decrease solubility, thereby producing a phosphor.

In this instance, the mixer MP2 and the main reactor 21 are connected via a nozzle passing through the main reactor 21 (see FIG. 2). Namely, the temperature of the preheated mixed solution not at a supercritical water temperature and the temperature of an upper portion of the main reactor 21 is also at a temperature near to a critical point of SCW because of heat loss. Accordingly, the mixed solution is sprayed from a deeper place than the inlet of the main reactor 21 via the nozzle provided therein. In a state where the main reactor 21 is at a SCW condition, the reaction is completed to crystallize a phosphor. Accordingly, phosphor particles having a uniform size are produced.

The main reactor 21 where a phosphor is produced is in the shape of a pipe made of a metal material and of which both ends are open. Also, main heaters 10 are attached on both sides of the main reactor 21 to form a SCW condition in the main reactor 21. The temperature of the main heater 10 is controlled by a temperature controller 9. In this instance, the main reactor 21 includes a temperature sensor 12 therein. The temperature sensor 12 functions to sense whether the main reactor 21 maintains a SCW condition, in particular, whether an outlet of the nozzle positioned in the main reactor 21 supplying a mixed solution maintains a SCW. Also, the temperature sensor 12 functions as a safety sensor preventing an accident caused by sudden temperature changes of the main reactor 21. Namely, a role as a safety sensor is to detect temperature changes and notify the event to an alarm (not illustrated) or a cutoff (not illustrated), so as to prevent an accident.

Fourth Process: Retrieving Phosphor

When a solution containing phosphors produced in the main reactor 21 passes through a condenser 13, the solution temperature becomes the same as room temperature and particles become condensed. Accordingly, phosphor particles and the solution are separated by filtering the particles via a reservoir filter 16. When separated phosphor particles are retrieved and dried, phosphor particles are finally obtained.

If a phosphor is produced by using a reactor according to the processes described above, a phosphor may be continuously produced without an additional heat treatment process for a short reaction time. Accordingly, it is economically efficient since time and energy can be saved.

Also, according to the method of the present invention, phosphor particles having uniform size and shape can be obtained. Accordingly, it is possible to use a phosphor in various fields such as PDP, FED, and the like.

Hereinafter, the present invention will be further described in detail with reference to examples and comparative examples. The examples are only for specifically describing the present invention. Thus, it will be apparent to those of ordinary skills in the related art that the scope of the present invention is not limited to the examples.

### EXAMPLE 1

### Synthesis of YAG:Eu Phosphor at a Supercritical Water (SCW) Condition

Synthesis of YAG:Eu phosphor at a SCW condtion is performed based on a chemical reaction of a formula as below:

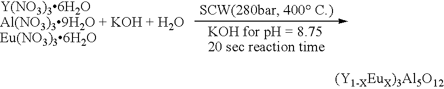

Namely, □ Yttrium nitrate hexahydrate (Y(NO₃)₃.6H₂O; manufactured by Strem Chemicals; purity 99.9%) of about 0.0135M, □ Aluminum nitrate nonahydrate(Al(NO₃)₃.9H₂O; manufactured by Wako Chemicals; purity 99.9%) of about 0.025M and □ Europium nitrate hexahydrate(Eu(NO₃)₃.6H₂O; manufactured by Strem Chemicals; purity 99.9%) of about 0.0015M were added and mixed in a 1 l tank of number 1 of the reactor 22 illustrated in FIG. 1, so as to produce Y_{2.7}Al₅O₁₂:Eu_{0.3}((Y₁-xEux)₃Al₅O₁₂ at x=0.1) phosphor. Also, potassium hydroxide solution (manufactured by Aldrich Chemicals; purity 99.99%) was added in a 1 l tank of number 2, and ionized water was added in a 1 l tank of number 3. Oxygen was completely removed from the ionized water by allowing nitrogen gas to collect oxygen gas.

Next, each of the ingredients in tanks 1 and 2 was supplied in the reactor via a high pressure pump 4 and mixed together in the MP1. In this case, the mixed solution had a pH of about 8.75. The solution mixed in the MP1 was mixed together with preheated water at a temperature of about 600° C. by using the pre-heater 7 and the temperature of the mixed solution became about 200° C.

The moment a mixed solution was supplied in the main reactor 21 including SCW at an environment of temperature of about 400° C. and about 280 bar, its solubility rapidly decreased and YAG(Y₃Al₅O₁₂):Eu was produced.

The temperature of the solution containing the produced phosphor was lowered to room temperature while passing through the condenser, and then phosphor particles were condensed in the solution. The condensed phosphor particles were retrieved via a reservoir filter. In this case, the solution was discharged to the outside via the upper portion of the filter. Phosphors collected in the filter were filtered again and only phosphor particles were retrieved. After this, the retrieved phosphor particles were dried at a temperature of about 105° C. for about a day and dried phosphor particles were obtained.

### COMPARATIVE EXAMPLE

### Production of YAG:Eu Phosphor by Solid-State Method

□ Yttrium nitrate hexahydrate(Y(NO₃)₃.6H₂O; manufactured by Strem Chemicals; purity 99.9%) of about 0.0135M, □ Aluminum nitrate nonahydrate(Al(NO₃)₃.9H₂O; manufactured by Wako Chemicals; purity 99.9%) of about 0.025M and □ Europium nitrate hexahydrate(Eu(NO₃)₃.6H₂O; manufactured by Strem Chemicals; purity 99.9%) of about 0.0015M were put in an agate bowl and a few drops of ethanol were dropped therein to make kneading. After this, it had been reacted in a furnace at a temperature of about 400° C. for about two hours. It was a lump since the kneading had been baked. The lump was grinded in a bowl. Calcination had been performed on the grinded powder for about four hours. After this, crystallized YAG:Eu phosphors were obtained.

[Test 1]

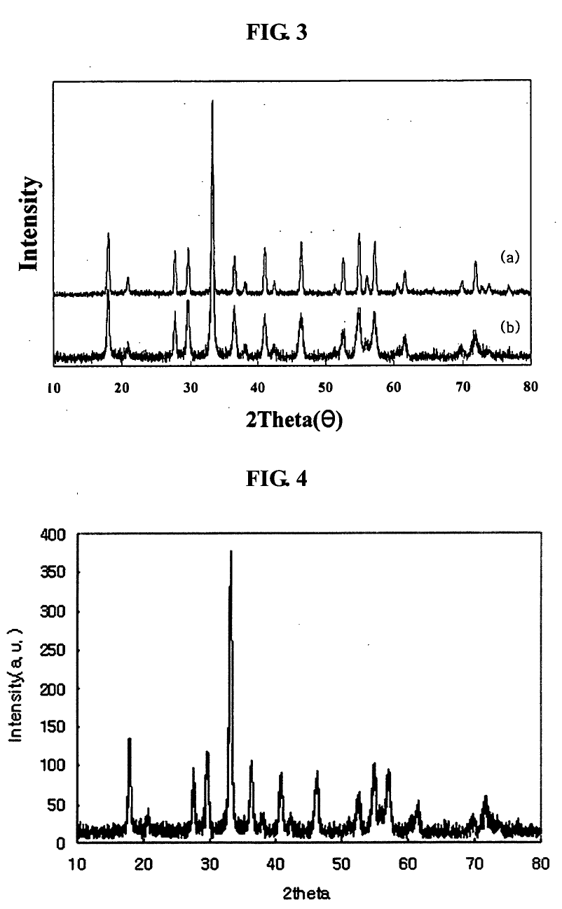

An X-ray diffraction (XRD) analysis of YAG:Eu phosphor produced in Example 1 and Comparative Example 1 was performed. Results thereof were respectively shown in FIGS. 3 and 4. In this instance, (a) of FIG. 3 showed analysis results of XRD using a standard material of YAG phosphor.

As a result, a YAG peak of a phosphor produced according to the method of the present invention (see (a) in FIG. 3), a YAG peak of a standard material (see (b) in FIG. 3), and a YAG peak of a phosphor produced by a solid-state method (see FIG. 4) were all substantially identical.

Accordingly, it was known that it was possible to produce a YAG crystal by a method using SCW of the present invention.

[Test 2]

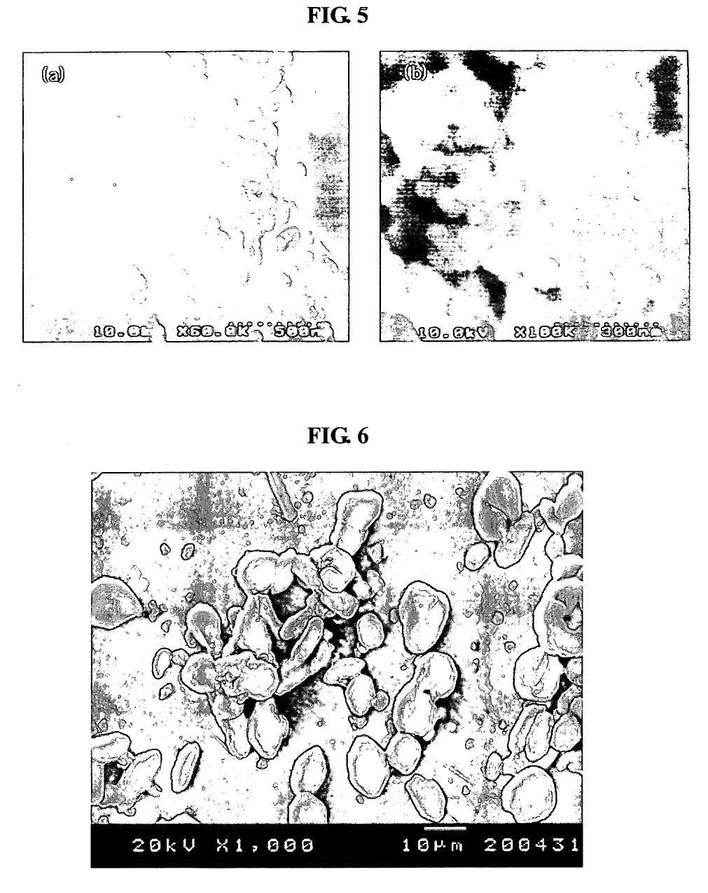

The shape and size of YAG:Eu phosphor particles produced in Example 1 and Comparative Example 1 was observed by using a scanning electric microscope (SEM). Each of SEM pictures was shown in FIGS. 5 and 6.

As a result, phosphors according to the method of the present invention were uniform particles having a spherical shape and a size of about 50 to about 70 nm (see FIG. 5). However, the shape of phosphors according to the solid-state method was irregular and the size thereof was also not uniform (see FIG. 6).

Accordingly, it was possible to provide phosphor particles having uniform size and shape by a method using SCW of the present invention.

[Test 3]

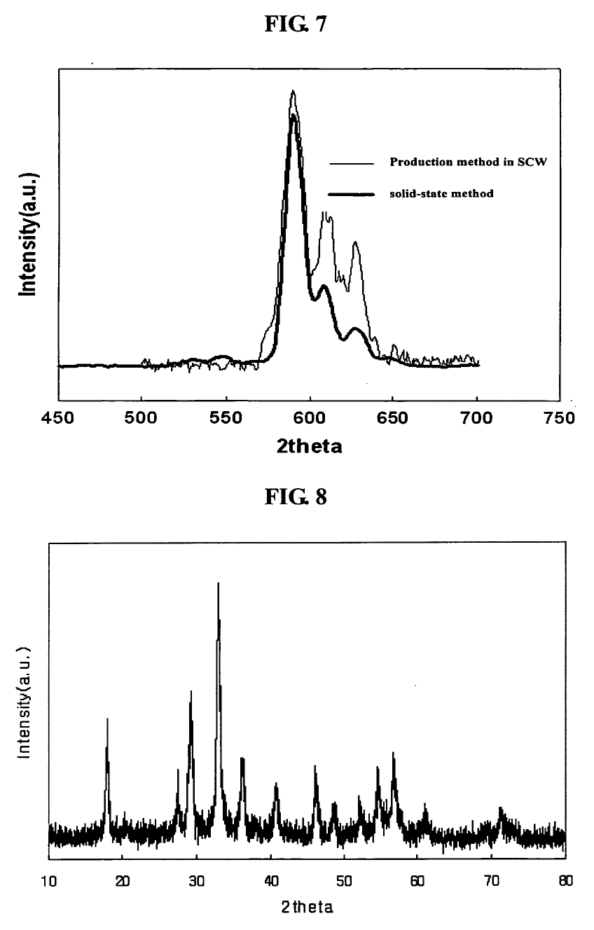

A luminosity of YAG:Eu phosphor produced in Example 1 and Comparative Example 1 was measured by a photoluminescence (PL) method. Results thereof were shown in FIG. 7.

FIG. 7 shows that luminosity of a phosphor produced according to the method of the present invention was similar to luminosity of a phosphor produced according to the conventional solid-state method.

Referring to results of the tests 1 to 3, the method of producing a phosphor at a SCW condition according to the present invention provided a phosphor having uniform size and shape and of which luminosity was similar to that of a phosphor produced according to the conventional solid-state method. Also, a reaction time was about 20 seconds which was much shorter than in the solid-state method. A separate heat treatment process was not needed to obtain crystalline particles. Accordingly, it was possible to know that the method of producing a phosphor according to the present invention was very economical in aspects of time and energy.

### EXAMPLE 2

### Production of YAG:Tb Phosphor Particles

Except for using terbium nitrate(YAG:Tb[10 at. %]) instead of europium nitrate and using a potassium hydroxide solution to control a mixed solution in the MP1 to have a pH of about 7.2, YAG:Tb phosphors were obtained by the same method as in the first example.

[Test 4]

The XRD analysis of YAG:Tb phosphor produced in Example 2 was performed. Results thereof were shown in FIG. 8. FIG. 8 shows that the XRD analysis results of YAG:Tb phosphor were substantially identical to aYAG peak of a standard material.

[Test 5]

YAG:Tb phosphor particles produced in Example 2 were observed by using the SEM.

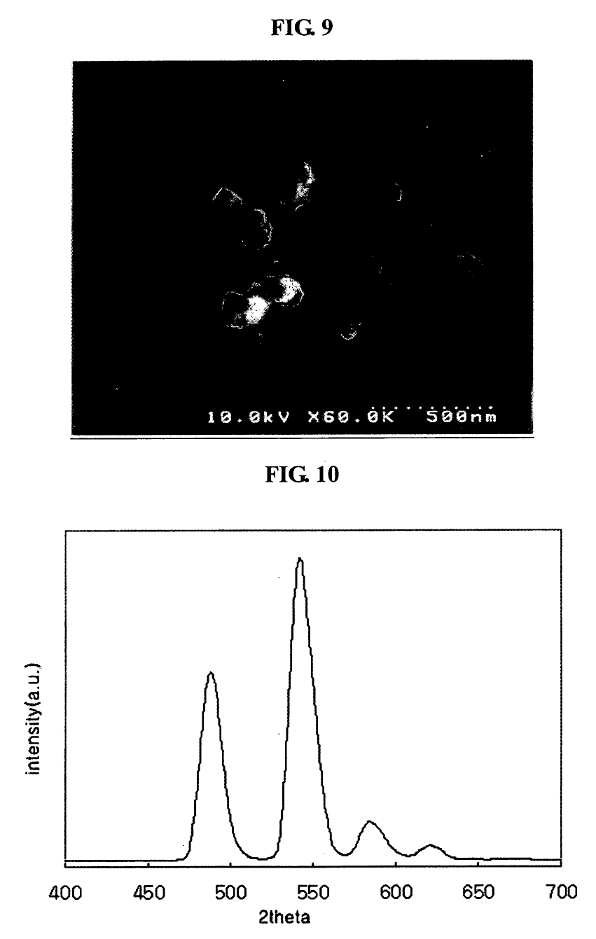

As a result, phosphors produced according to the method of the present invention were uniform particles having a substantially cuboid shape (see FIG. 9).

[Test 6]

Luminosity of YAG:Tb phosphor produced in Example 2 was measured via the PL method. Results thereof were shown in FIG. 10.

Referring to Tests 6 to 8, according to the method of producing a phosphor at a SCW condition of the present invention, it was possible to obtain phosphor particles having uniform size and shape although Tb was used as an activator instead of Eu.

Accordingly, the method of the present invention is applicable to production of a phosphor doped with various rare-earth metals.

As described above, in the case the method of producing a phosphor according to the present invention is performed by using a reactor for producing a phosphor according to the present invention, it is possible to continuously produce a phosphor of which the size and shape of particles is uniform while showing luminosity similar to that of a phosphor produced according to the conventional solid-state method. Accordingly, a phosphor produced according to the method of the present invention is applicable in various fields demanding the characteristic as above, such as PDP and the like.

Also, in the method of producing a phosphor according to the present invention, the total reaction time is within about one minute which is shorter than in the solid-state method. Also, since a separate heat processing process is not needed to obtain crystallized particles, it is efficient in aspects of time and energy.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A method of producing a phosphor at a condition of supercritical water, the method comprising:
mixing together a water-soluble metal salt solution containing a host and an activator doping the host, and an alkaline solution to react to each other, and converting the water-soluble metal salt solution to a hydroxide salt solution;
mixing together the hydroxide salt solution and preheated water to maintain a temperature of the mixed solution in a range from about 150 to about 200° C.;
injecting the mixed solution into a main reactor in which a state of supercritical water is maintained to produce phosphor particles; and
condensing, filtering and drying the produced phosphor to retrieve the phosphor particles.

2. The method of claim 1, wherein the host includes yttrium or aluminum.

3. The method of claim 1, wherein the activator includes rare-earth metals.

4. The method of claim 3, wherein the rare-earth metal comprises at least one selected from the group consisting of scandium, ytterbium, lanthanum, cerium, praseodymium, neodymium, samarium, europium, gadolinium, terbium, dysprosium, holmium, erbium, thulium, yttrium, and lutetium.

5. The method of claim 1, wherein the water-soluble metal salt includes a nitrate, an acetate, or a hydrochloride.

6. The method of claim 1, wherein the hydroxide salt solution has a pH of about 7.1 to about 12.

7. A phosphor produced according to the method of claim 1.

8. The phosphor of claim 7, wherein the phosphor includes YAG (Y₃Al₅O₁₂) doped with europium (Eu) or terbium (Tb).

9. A reactor for producing a phosphor comprising:
an inlet supplying a water-soluble metal salt solution containing a host and an activator doping the host, and an alkaline solution;
a mixer mixing together the water-soluble metal salt solution and the alkaline solution supplied from the inlet;
a main reactor connected to the mixer and maintaining a supercritical water condition therein to produce the phosphor;
a pre-heater supplying preheated water to between the mixer and the main reactor;
a condenser condensing phosphor particles produced at the main reactor to be condensed; and
a reservoir filter retrieving the condensed phosphor particles.

10. The reactor of claim 9, wherein:
the mixer comprises a first transfer pipe transferring the metal salt solution and a second transfer pipe disposed adjacent to the first transfer pipe and transferring the alkaline solution, the first and second transfer pipes spatially connected to each other at the end portion of the first transfer pipe, and
the pre-heater comprises a third transfer pipe supplying the preheated water.

11. The reactor of claim 10, wherein the alkaline solution is transferred to between the first and second transfer pipes.

12. The reactor of claim 10, wherein the metal salt solution and the alkaline solution are mixed together between a connection portion of the first and second transfer pipes and a cross portion of the second and third transfer pipes.

13. The reactor of claim 9, wherein the mixer is connected to the main reactor via a nozzle passing through the main reactor.

14. The reactor of claim 10, wherein the mixer is connected to the main reactor via a nozzle passing through the main reactor.
